(19) United States
(12) Patent Application Publication
(10) Pub. No.: US 2002/0024809 A1
(43) Pub. Date: Feb. 28, 2002

(54) Decorative lights mounted to plastic netting

(76) Inventor: Renato Openiano, San Diego, CA (US)

Correspondence Address: William C. Fuess, Fuess and Davidenas, Attorneys at Law, 10951 Sorrento Valley Road, Suite II-G, San Diego, CA, 92121-1613, US

(21) Appl. No.: 09/938,717

(22) Filed: Aug. 24, 2001

Related U.S. Application Data
(60) Provisional application No. 60/227,857, filed on Aug. 24, 2000.

(51) Int. Cl. F21V 21/00

(52) U.S. Cl. 362/249; 362/252; 362/806

(57) ABSTRACT

Miniature lights are mounted to flexible-grid-type plastic-netting-type backing material to form a decorative display panel. A lamp holder of each miniature light is passed through a respective first, preferably tight, grid hole of the backing material to assume position on a second side while interconnecting wires remain substantially on a first side. A preferably integral wire holder portion, most preferably two hook extensions, of each lamp holder are passing through a respective second hole of the backing material, preferably one or more holes distant from the corresponding first hole, to the first side of the backing material. The wire holder, or hooks, there capture and hold the interconnecting wires, stably mounting the lamp holders and the miniature lamps to the backing material at predetermined spacing and uniform angular orientation. The panels of backing materials preferably have complimentary attachment features at opposite edges, permitting the mechanical connection of multiple panels and their associated, patterned and arrayed, miniature lights.

### RELATION TO A PROVISIONAL PATENT APPLICATION

The present patent application is descended from, and claims benefit of priority of, U.S. provisional patent application Ser. No. 60/227,857 filed on Aug. 24, 2000 for IMPROVED DECORATIVE LIGHTS SYSTEM USING PLASTIC NETTING TYPE BACKING MATERIAL to the selfsame inventor as the present patent application.

### BACKGROUND OF THE INVENTION

1. Field of the Invention

The present invention generally concerns decorative lights, and arrays of decorative lights.

The present invention particularly concerns the regular mounting of miniature electrical lights to a grid, plastic-net-type, flexible, backing substrate where the backing substrate may be rolled for transport and storage, and unrolled with the regularly arrayed lights energized for the purpose of making a decorative display, a sign, or the like.

2. Description of the Prior Art

It is known to mount lights to planar surfaces, including surfaces that are flexible to fold or to roll in order to be compacted for transport and/or storage. The lights on the surfaces may be arrayed and/or patterned for decorative purposes, such as for Christmas or U.S. Independence Day displays.

The present invention will be seen to concern a method for mounting miniature lights in a regular array to a flexible apertured surface having the topology of a fish net, and an array of decorative lights so constructed. Such a surface has the advantages of minimum material usage, light weight, maximum flexibility, and, when constructed of inexpensive but durable and strong plastics and the like, longevity. The lights will be seen to be easily accessible for replacement and maintenance repair. The entire assembly is easily unrolled, hung, energized for display; and re-rolled, transported and stored, for indefinitely many cycles.

### SUMMARY OF THE INVENTION

The present invention contemplates a decorative lights assembly having a number of miniature lights preferably self inter-lockingly attached to a flexible-grid-type plastic-netting-type backing material.

1. A Decorative Lights Assembly

The decorative lights assembly in accordance with the present invention preferably has six parts, namely, 1) a number of miniature lights, each within a 2) lamp holder that is self-affixed to 3) plastic-netting-type backing material, with 4) interconnecting wires between the miniature lights for both electrical connection and, especially at time of fabrication, mechanical support plus, normally additionally, 5) a lights electronic controller box, electrically connected to the power grid (not part of the invention) by 6) an A.C. cord and plug.

The preferred 2) lamp holder is substantially cylindrical, with 2a) an open-ended lamp socket at one, first, end, with 2b) an integral wire holder, or clamp, situated at or about the rim of the open end portion of this socket. The 2a) open-ended lamp socket receives and electrically connects one of the 1) miniature lights. The 2b) integral wire holder passes through each of two close, but not normally adjacent, holes in, and defined by, the 3) plastic-netting-type backing material. By grabbing some of the physical substance of this 3) plastic-netting-type backing material, the 2b) integral wire holder serves to mount the 2) lamp holder (and its plugged 1) miniature light) to this 3) plastic-netting-type backing material. At the other, second, end of the substantially cylindrical 2) lamp holder, electrical connection is made to the 4) interconnecting wires.

The 2) lamp holder's integral 2b) wire holder is preferably constructed with two opposing hooks. When the 2) lamp holder is mounted by its integral 2b) wire holder to the 3) plastic-netting-type backing material then it is preferably entirely situated on one side of this 3) plastic-netting-type backing material while the most of the 4) interconnecting wires are situated on the opposite side of the 3) plastic netting backing material. The entire decorative lights assembly thus looks regular and orderly, and is aesthetically appealing.

The miniature lights as are held to the backing material are normally spaced and located during assembly so as to form a regular geometric or decorative pattern when lit. They are preferably spaced less than 3 inches apart, typically end to end in a straight lines with, most preferably, a tip of each miniature light bulb pointing towards the second end of the next light bulb in series. Less spacing between the miniature lights produces a tighter and better pattern definition.

The plastic-netting-type backing material is preferably made of plastic. It is preferably flexible and easily bendable with no, or minimum, pre-existing bent shape bias. However, the backing material is preferably not limp, but is instead semi-rigid non-electrically conductive plastic, preferably of the type (i) that can be fully bent and unbent dozens of times without being damaged, (ii) that can withstand outdoor weather exposure for an extended period without damage, (iii) that is flame retardant, and/or (iv) that can be cut with a blade-type cutting tool.

The preferred plastic netting type backing material has grid holes of square or rectangular shape, although holes of any shape arrayed in a regular or semi-regular grid are suitable. The grid holes are preferably of a size just sufficient to permit the miniature lights lamp holder to pass through longitudinally with some slight maneuvering. The grid holes are most preferably sized so that the distance from the inside part of a first grid hole to the inside part of a second next adjacent, or third, grid hole is preferably approximately the length of the lamp holder. There is thus preferably at least one open grid hole located in between a first grid hole and a third grid hole, though which first and third grid holes respectively pass the wires (to the lamp holder), and the two opposing hooks of the lamp holder's wire holder.

During construction, the lamp holders—preferably already loaded with miniature lights—are inserted through the first grid hole in a first direction sense and become situated in the second side of the plastic-netting-type backing material. The hooks of the wire holder of each lamp holder are then inserted in the opposite directional sense into a corresponding third grid hole, causing that a portion of the hook ends of this wire holder of each lamp holder will come to be protruding into space upon the first side of the plastic-netting-type backing material. A proximate portion of the corresponding adjacent inter-connecting wire present on the first side of the plastic-netting-type backing material is then inserted into the region between the hooks of the protruding wire holder. These hooks serve to capture and constrain this wire.

The passage of the hooks through the (preferably) third hole, and their subsequent capture of the wire, thus creates an inter-locking means. Namely, insertion of the wire into the region of the hooks protruding through the third hole serves to provide a positive attachment of the light holders, and the miniature lights, to the plastic-netting-type backing material. Moreover, the miniature lights are orderly maintained all pointing in the same direction, a direction that is normally parallel to an axis of the plastic-netting-type backing material surface.

Electrically, the interconnecting wires connect one miniature light to the next miniature light in the same circuit. There are thus only a limited number of different circuits in the most preferred embodiments of this invention, although more circuits exhibiting a greater variety of visual effects can be added if wanted. Interconnecting wires electrically connect the miniature lights to the electronic control box, and also connect this electronic control box to an A.C. plug and power grid. The lights electronic controller box typically consists of an electronic circuit inside a plastic housing, and serves to control the turning on and off of the miniature lights. Each electronic controller is preferably capable of controlling two or more miniature lights circuits, the several controlled circuits permitting the separate and selective turning on and off of all the different miniature lights (and/or groups of lights) of all the different light circuits.

2. Assembly of Miniature Decorative Lights to a Flexible-grid-type Plastic-netting-type Backing Material Where Lamp Holders or Portions Thereof are Twice Inserted, Once in Each Direction, Through Different Holes in the Backing Material

In another of its aspects, the present invention is embodied in a method of assembling miniature decorative lights to a flexible-grid-type plastic-netting-type backing material. The backing material preferably of the flexible-grid-type plastic-netting-type is most commonly made of molded plastic.

The method transpires by first inter-connecting together the miniature lights with their correspondingly sized (cut to desired length) inter-connecting wires. Miniature lights are then longitudinally inserted to their respective first grid holes, with the locations of the first grid holes already being pre-selected so that these lights will form the desired decorative light shape or pattern. By this insertion each miniature light is individually transferred from the first side of the plastic netting type backing material to the second side.

In detail a lamp holder having a wire holder is maneuvered first through respective first grid holes, and then the wire holder of each of the lamp holders—by now on the second side of the plastic netting type backing material—is inserted into a preselected respective third grid hole, therein creating a protrusion of the wire holder of the lamp holder into space on the first side of the plastic netting type backing material.

Then at least one of the corresponding adjacent interconnecting wires at the first side of the plastic netting type backing material is inserted into this protruding wire holder through a gap or hole in this wire holder, effectively creating an inter-locking means anchoring the lamp holder and any (miniature) lamp that is plugged into the lamp holder.

By this insertion, and this method, the inter-connecting wire residing inside of the protruding portion of the wire holder serves to provide a positive attachment means for (i) anchoring miniature lights to the plastic netting type backing material while also (ii) keeping the miniature lights in equal angular alignment, normally in longitudinal parallel to an axis of the plastic netting type backing material.

In a variant of the method the miniature light bulbs are not installed into their respective lamp holders during the initial assembly process. Instead, the wired lamp holders are inserted into their respective first grid holes of the plastic netting type backing material without their respective miniature lights. The miniature lights are only then inserted into their respective lamp holders sometime after the lamp holders have been inserted and transferred to the second side of the plastic netting type backing material. This variant of the method minimizes the risk of these bulbs being un-seated from their respective lamp holders, and also minimizes exposing these lamps to wear, rough handling, shock and vibration during the initial assembly process;

3. Assembly of Miniature Decorative Lights to a Flexible-grid-type Plastic-netting-type Backing Material Where the Lights Are Substantially on Only One Side of the Backing Material and the Wires Are Substantially Only on the Other Side

In another of its aspects, the present invention is embodied in a method of assembling miniature decorative lights to a flexible-grid-type plastic-netting-type backing material wherein (i) a majority of the interconnecting wires originates on the first side of the plastic netting type backing material, (ii) an end portion of each one of pre-cut interconnecting wires are first inserted into the respective first grid hole, (iii) particular wire ends that are already on the second side of the plastic netting type backing material are then inserted into the second end part of their respective lamp holder which part is already on the second side of the plastic netting type backing material, and (iv) at least 2, and more preferably 3 or 4, of these pre-cut interconnecting wires are connected per lamp holder, therein creating a secure electrical connection for the lamp holder to the rest of the circuit.

In detail, during the (iv) connecting, each lamp holder's wire holder is inserted into pre-selected respective third grid holes, therein coming to protrude onto the first side of the plastic-netting-type backing material. Then at least one of the adjacent interconnecting wires on the first side of the plastic-netting-type backing material is inserted into the protruding holder through the a gap or hole in the wire holder. By action of both these insertions a positive attachment of the miniature lights to the plastic-netting-type backing material is realized. Moreover, the attachment is realized in such a way that the installed miniature lights are parallel with a major axis of the plastic netting type backing material.

The miniature light bulbs are preferably then inserted to the lamp holders sometime after the interconnecting wires are inserted into the second end part of the lamp holder.

4. Variations on the Miniature Light Assembly, and the Assembly Methods, of the Present Invention

The miniature lights of a light assembly in accordance with the present invention may be electrically connected in series, parallel or series-parallel.

The decorative shape(s) formed by the miniature lights may be any of traditional Christmas figures such as Santa Claus, reindeer, Nativity Scene and the like, patriotic themes such as a flag, and/or any number of parallel longitudinal lines.

The parallel longitudinal lines, in particular, that are formed by the multiple miniature lights may be so formed as any of a series, parallel, or series-parallel circuit.

It is also possible that the parallel longitudinal lines formed by the multiple miniature light circuits strings are oriented in such a way that if lights “a”, “b”, “c” or “d” of each of several stringed lights circuits as serve to energize the parallel longitudinal lines are lighted, then a series of slanted diagonal lines are formed. However, if these “a”, “b”, “c” or “d” lights of each of these plurality of parallel longitudinal lines are lighted in sequence, then a series of slanted diagonal lines will appear to move sideways throughout the length of the longitudinal lines of light.

Similarly, but alternatively, lights “a”, “b”, “c” or “d” of each of the stringed light circuits of the parallel longitudinal lines may form when lighted a series of “arrow head” shapes. If these “a”, “b”, “c” or “d” lights are appropriately lighted in sequence, then a series of “arrow head” shapes will appear to move sideways throughout the length of the longitudinal lines of light.

Likewise, and similarly, a series of vertical lines moving sideways throughout the length of the longitudinal line of light may be formed and depicted.

The decorative shape formed by the miniature lights may be a single longitudinal line created when a single string of the miniature lights is assembled into a plastic netting backing material having the width of but a single grid hole. Alternatively, the same decorative shape—the longitudinal line—may be formed by assembling the miniature lights to the plastic netting backing material when this plastic netting backing material is two, there, four or even more grid holes in width.

Importantly, the grid matrix supporting the arrayed miniature lights may be, and preferably is, substantially rectangular with a first portion of several mechanical attachment features along on edge and with a complimentary second portion of the same mechanical attachment features located in the same relative positions along of a second, opposite, edge. The attachment features, or tieing means, may be, and preferably are, integrally formed as chord, tape, ribbon, wire or rope ties, or as plug and socket receptacles. The attachment features of a same light display on one grid matrix may be mated, causing the light display to assume a hollow cylindrical, or tubular, topology. However, more commonly the attachment features of several grid matrixes each supporting one light display are mated daisy-chain fashion, one display to the next. The attachment features preserve a like spacing between the end lights of successive displays to the spacing of the lights within each display. Thus the several mechanically joined matrixes and light displays serve, when each is electrically powered, to produce a unified display of extended size.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a top view of a mini-light on flexible plastic netting type backing material.

FIG. 2 is a bottom view of the mini-light on the flexible plastic netting type backing material.

FIG. 3 is a right side view of the mini-light on the flexible plastic netting type backing material.

FIG. 4 is a left side view of the mini-light on the flexible plastic netting type backing material.

FIG. 5 is a front view of the mini-light on the flexible plastic netting type backing material.

FIG. 6 is a rear view of the mini-light on the flexible plastic netting type backing material.

FIG. 7 shows the orientation and electrical schematic of the miniature lights for producing vertical lines of lights perpendicularly to the plurality of longitudinal light strings.

FIG. 8 shows the orientation and electrical schematic of the miniature lights for producing arrowhead lines of lights along the plurality of longitudinal light strings.

FIG. 9 shows the orientation and electrical schematic of the miniature lights for producing slanted lines of lights along the plurality of longitudinal light strings.

FIG. 10 is a view of a portion of a panel of decorative lights in accordance with the present invention showing the attachment features that permit physical connection of successive panels in a daisy chain.

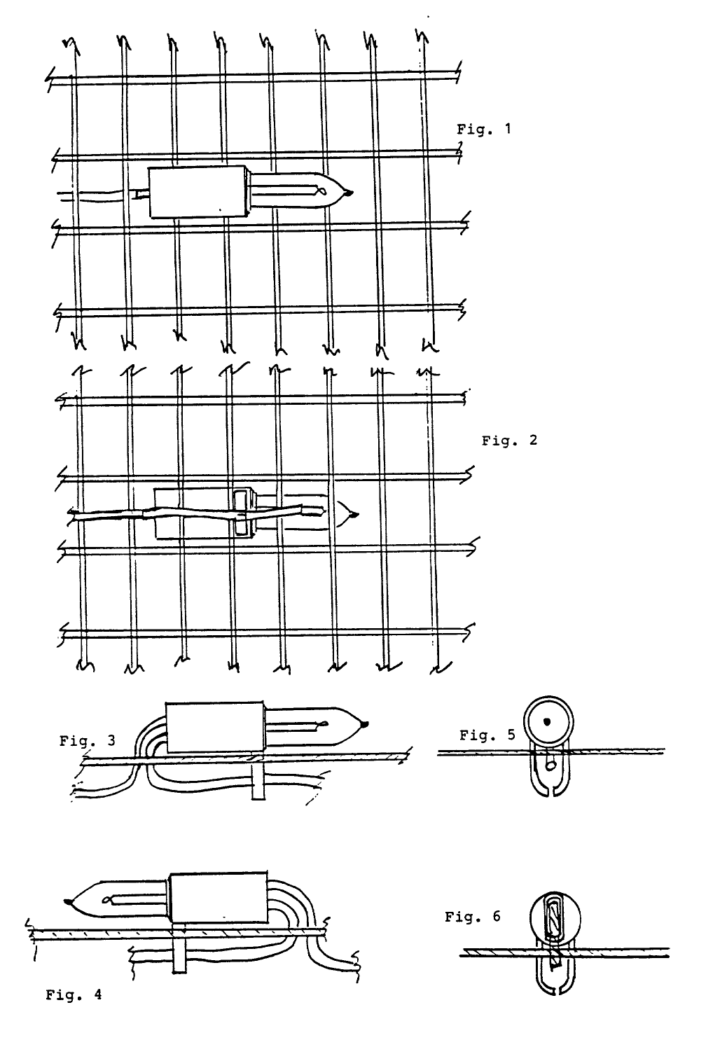

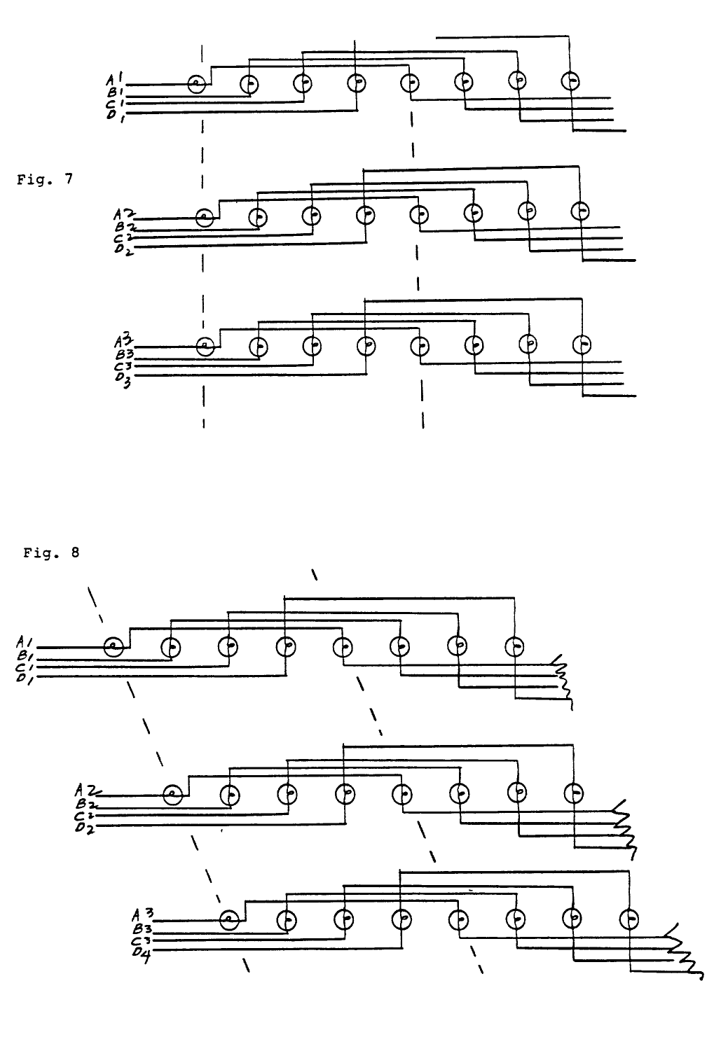

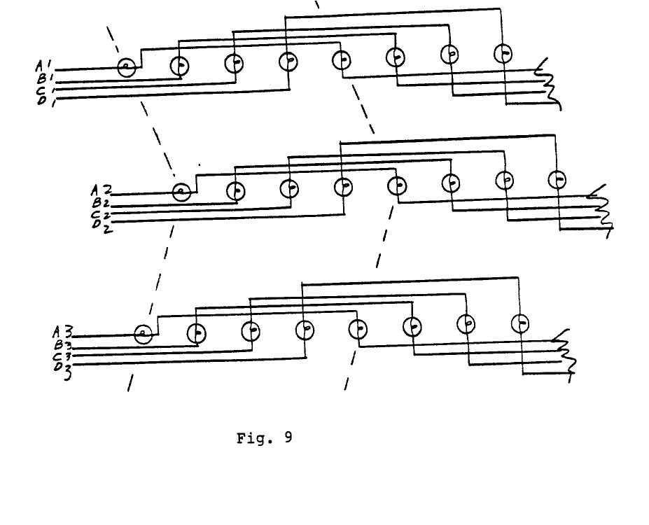

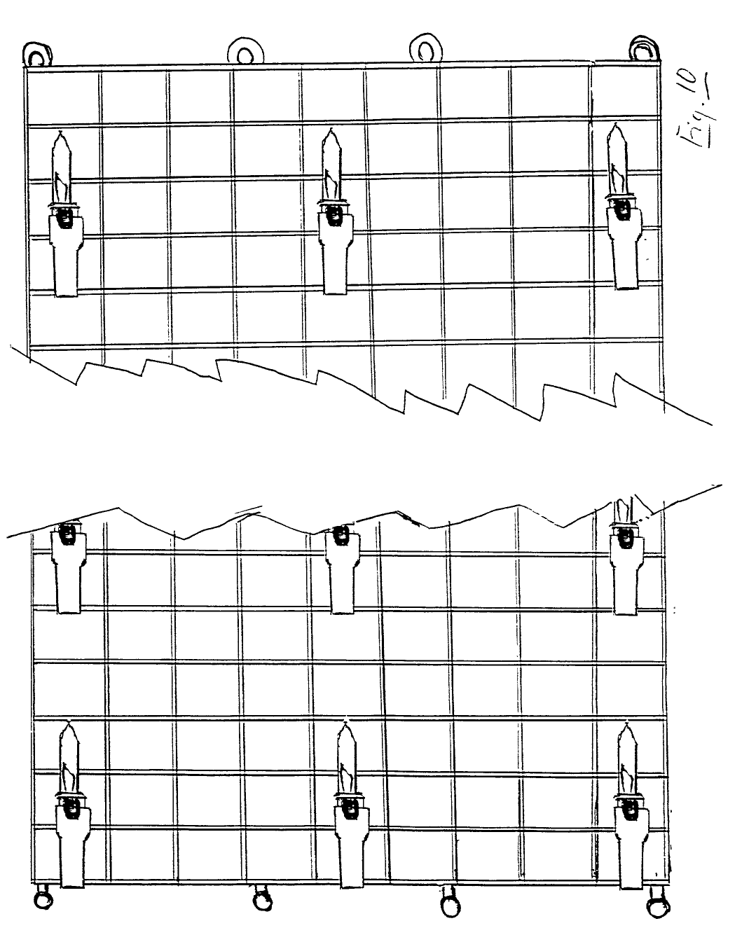

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

The light display of the present invention as shown in the figures includes mini-lights, plastic netting type backing material, inter-connecting wires, a lights electronic controller box, and an A.C. plug. The mini-lights preferably include an assembly comprising of the lamp-holder and mini-lamp bulb plugged in this lamp-holder, the lamp-holder which acting as the mini-lamp socket. This lamp-holder is preferably the type having a wire holder situated at or about the rim of the open, or first, end portion of the lamp-holder. The second end of the lamp-holder is where inter-connecting wires are situated.

This wire holder of the lamp-holder preferably consists of two opposing hooks as best illustrated in drawing FIGS. 3-6. The mini-lights when fully installed in the plastic netting type backing material are preferably situated on the second side of this plastic netting type backing material while the bulk of the inter-connecting wires are situated on the first side of this plastic netting backing material. Because the inter-connecting wires are situated on the first side of the plastic netting type backing material and are held by the wire holders of the lamp holders, the assembly is, and looks, organized and orderly.

The mini-lights are normally assembled to form a decorative pattern when lit and preferably spaced less than 3 inches apart in series, end to end, preferably with the tip of each light bulb pointing towards the second end of the next lamp-holder in series, with the less spacing between the mini-lights producing a better definition.

The plastic netting type backing material is preferably made of plastic, and is preferably (i) flexible and easily bendable with (ii) minimum previous bent shape bias, (iii) semi-rigid, and (iv) non-electrically conductive. The plastic netting type backing material can be fully bent and unbent dozens of tunes without being damaged, and more preferably can withstand outdoor weather exposure for an extended period without damage. it is further preferably flame retardant, and of a type that can be cut with a common hand held bladed cutting tool.

This plastic netting type backing material preferably has holes or any of square, rectangular or other regular geometric shape in, preferably, a regular grid. The size of each grid hole is preferably just large enough to permit the mini-lights lamp holder to pass through longitudinally with some slight maneuvering of the wire bolder's hole. The grid holes are preferably sized so as the distance from the inside part of a first grid hole to the inside part of a second next adjacent, “third”, grid hole is preferably approximately the length of the lamp-holder. This preferably leaves, of course, at least one grid hole—the “second” grid hole—in between first grid hole and third grid hole.

After the mini-lights are inserted through the first grid hole and become situated in the second side of the plastic netting type backing material, the lamp-holder's wire holder is inserted into its corresponding third grid hole. This makes that this wire holder extends though the third hole with its lower portion assuming a position protruding into space on the first side of the plastic netting type backing material.

It there engages a corresponding, adjacent, inter-connecting wire. It does so—entirely on the first side of the plastic netting type backing material—by act of inserting the interconnecting wire to the inside of the gap, or cavity, of the wire holder formed by, and between, its two hooks. Thus this gap or cavity in this wire holder serves to create an interlock, the insertion of the interconnecting wire into the gap of the protruding portion of the wire holder serving to—in accordance with the present invention—provide a positive attachment of both the mini-lights and the interconnecting wires to the plastic netting type backing material.

Moreover, this preferred attachment also serves to keep the mini-lights preferably longitudinally in parallel to the plastic-netting-type backing material. The inter-connecting wires connect one mini-light to the next mini-light in the same circuit where each circuit is in accordance with this invention. A greater variety of effects may preferably be achieved if more circuits are added.

The same inter-connecting wires also connects the mini-lights to the electronic control box and connect the A.C. plug to the lights electronic controller box. The lights electronic controller box normally includes an electronic circuit inside a plastic housing. It controls the turning on and off of the mini-lights, and is preferably capable of controlling two or more mini-lights circuits. Thereby having several controlled circuits permits the separate and selective turning on and off of different light circuits, and/or the selective turning on and off of particular group of lights.

During assembly of the mini-lights to the flexible-grid-type plastic-netting-type backing material the lamp holders are first inter-connecting together by appropriately sized (cut to desired length) interconnecting wires. Each lamp holder is then longitudinally inserted through a respective first grid hole. These first grid holes are, or course, patterned and pre-selected so that the collective lights will form the desired decorative light shape/pattern. By this inserting the lamp holders of the mini-lights are individually transferred from the first side of the plastic netting type backing material to the second side. The required maneuvering for this insertion of the lamp holders is delicate because the holes are preferably tight.

Once each lamp holder is inserted through its respective first grid holes, then the wire holder portion of this lamp holder—which lamp holder is now on the second side of the plastic netting type backing material—is inserted into a pre-selected respective third grid holes. It there protrudes in part into the space at the first side of the plastic-netting-type backing material. At this location, and protrusion, at least one of the corresponding adjacent inter-connecting wires at the first side of the plastic-netting-type backing material is then captured.

This capture preferably transpires by slipping the wires into a cavity between two hooks of the lamp holder' wire holder. This cavity, or hole, or a gap is the way by which the wire holder hole preferably creates an interlock. This insertion of one or, preferably, all adjacent ones of the inter-connecting wires into the inside of the protruding portion of the wire holder thus serves to provide a positive attachment of the lamp holders, and the mini-lights, to the plastic netting type backing material while also, preferably, keeping the mini-lights evenly spatially angularly oriented. This illustrated orientation is longitudinally in parallel to a major axis of the plastic netting type backing material.

The mini-light bulbs may be 1) installed into their respective lamp-holders during the initial assembly process—wherein the wired lamp-holders are thus inserted into their respective fist grid holes of the plastic netting type backing material with their respective mini-lamps already inserted—or 2) inserted later, and sometime after the lamp holders have been inserted through, and transferred to the second side of, the plastic-netting-type backing material. The 2) later insertion minimizes the risk of these miniature light bulbs being un-seated from their respective lamp holders, and also minimizes exposing the miniature light bulbs to wear, rough handling, shock and vibration during the initial assembly process.

A portion of a panel of decorative lights in accordance with the present invention showing edge attachment features that permit physical connection of successive panels in a daisy chain is shown in FIG. 10. The preferred complimentary mating features are balls, or headed studs, at one edge that fit into, and that are retained by, complimentary loops, or apertures on the opposite edge of a next panel.

In accordance with the preceding explanation, variations and adaptations of the decorative lights assembly method, and assembly, in accordance with the present invention will suggest themselves to a practitioner of the electrical, mechanical and lighting arts.

In accordance with these and other possible variations and adaptations of the present invention, the scope of the invention should be determined in accordance with the following claims, only, and not solely in accordance with that embodiment within which the invention has been taught.

What is claimed is:

1. A decorative lights system composing:
a plurality of miniature lights; each within
a lamp holder; that is affixed to
netting-type backing material; with
interconnecting wires between the lamp holders and, through the lamp holders, to the miniature lights that are within the lamp holders.

2. The decorative lights system according to claim 1 wherein the lamp holder comprises:
a body fitting through a first hole in the netting-type backing material in a first directional sense;
a wire holder, affixed to the body, fitting through a second hole in the netting-type backing material in a second directional sense, and grabbing and holding where protruding through the netting-type backing material the interconnecting wires;
wherein the lamp holder is, in substantial portion other than the extension of its wire holder through the second hole in the netting-type backing material, substantially on one side of netting-type backing material while the held interconnecting wires are, in substantial portion other than the extension through the first hole in the netting-type backing material to the lamp holder, substantially on the other side of netting-type backing material.

3. The decorative lights system according to claim 2
wherein the netting-type backing material has and presents a regular grid array of holes;
wherein the first hole in the netting-type backing material through which the body of the lamp holder fits is separated by at least one full hole from the second hole in the netting-type backing material through which the wire holder of the lamp holder fits.

4. The decorative lights system according to claim 2
wherein the first hole in the netting-type backing material is just large enough to permit passage of the lamp holder properly spatially oriented.

5. The decorative lights system according to claim 2
wherein the lamp holder is substantially cylindrical, with an open-ended lamp socket at one, first, end; and
wherein the wire holder is situated at the rim of the open end portion of this socket.

6. The decorative lights system according to claim 2 wherein the lamp holder's wire holder comprises:
two hooks.

7. The decorative lights system according to claim 1
wherein each of the plurality of miniature lamps has a base within the lamp holder and an exposed tip; and
wherein the exposed tips of all the plurality of miniature lamps point in the same direction.

8. The decorative lights system according to claim 1 further comprising:
connection features for attaching end-to-end plural panels of the flexible-grid-type plastic-netting-type backing material, each panel having a plurality of miniature decorative lights.

9. A method of assembling miniature decorative lights each within a lamp holder to a flexible-grid-type plastic-netting-type backing material comprising:
inter-connecting together lamp holders holding the miniature lights with inter-connecting wires;
inserting each lamp holder through a respective first grid hole on the flexible-grid-type plastic-netting-type backing material, making that each lamp holder is individually transferred from a first side of the flexible-grid-type plastic-netting-type backing material to a second side;
passing back a wire holder portion of each lamp holder from the second side to the first side of the flexible-grid-type plastic-netting-type backing material through a respective second hole; and
clamping at the first side of the flexible-grid-type plastic-netting-type backing material the inter-connecting wires with the wire holder portion of each lamp holder.

10. The assembly method according to claim 9 that before the inserting comprises:
plugging miniature lamps to the lamp holders.

11. The assembly method according to claim 9 that after the clamping comprises:
plugging miniature lamps to the lamp holders.

12. The assembly method according to claim 9 further comprising:
attaching end-to-end plural panels of the flexible-grid-type plastic-netting-type backing material each panel with assembled miniature decorative lights.
